(19) United States
(12) Patent Application Publication
(10) Pub. No.: US 2011/0107979 A1
(43) Pub. Date: May 12, 2011

(54) Dressage whip and system and method for guiding a horse

(75) Inventor: Marcia Rigg, Chicago, IL (US)

(73) Assignee: D-Cue Products, Inc.

(21) Appl. No.: 12/927,068

(22) Filed: Nov. 5, 2010

Related U.S. Application Data
(60) Provisional application No. 61/260,497, filed on Nov. 12, 2009.

(51) Int. Cl. A01K 15/02; B68B 11/00

(52) U.S. Cl. 119/712; 231/4

(57) ABSTRACT

A dressage whip for guiding a horse may have a curved segment and a tip. The curved segment may connect a first segment to a second segment, and the first segment and the second segment may be substantially co-linear. The curved segment may accommodate a thigh of a rider of a horse and may maintain the tip in a position proximate to the horse. The dressage whip may have a handle which may be a shaft having a substantially oval cross section formed by two opposed substantially flat sides and two opposed substantially curved sides.

This application claims the benefit of U.S. Provisional Application Ser. No. 61/260,497, filed Nov. 12, 2009.

### BACKGROUND OF THE INVENTION

The present invention generally relates to a dressage whip and a system and a method for guiding a horse. More specifically, the present invention relates to a dressage whip which may have a curved segment and a tip. The curved segment may accommodate the thigh of a rider of the horse and may maintain the tip in a position proximate to the horse.

Dressage is a type of competitive horse riding which involves the rider guiding a horse through a series of complex maneuvers using slight movements of the hands, legs and weight of the rider. Ideally, a dressage horse may smoothly respond to a slight movement of the rider by performing the corresponding maneuver while remaining relaxed and appearing effortless.

Dressage riders use a dressage whip to touch the side of the horse while keeping both hands on the reins. Known dressage whips, such as those disclosed in U.S. Pat. Nos. 7,387,232, 6,065,670, 4,863,095 and D593,716 and U.S. Patent Application Publication Nos. 2008/0230593, 2007/0284427, 2007/0080201 and 2005/0126133, are a slightly flexible rod with a strap of leather affixed to one end of the rod. The dressage whip may be used to supplement or amplify other cues communicated to a horse by a rider. The ability of the rider to apply almost invisible cues to the horse is critical for successful dressage riding. Training and competition emphasize that the rider quietly and imperceptibly apply the dressage whip to the horse.

However, holding both the reins and a known dressage whip simultaneously and continuously may be difficult for the rider. Moreover, using a known dressage whip requires perceptible movements of the hand of the rider which are noticeable and, accordingly, discouraged in competitive dressage. Therefore, a need exists for an improved dressage whip which enables a horse to be cued with reduced movement by the rider.

### SUMMARY OF THE INVENTION

The present invention generally relates to a dressage whip and a system and a method for guiding a horse. More specifically, the present invention relates to a dressage whip which may have a curved segment and a tip. The curved segment may accommodate the thigh of a rider of the horse and may maintain the tip in a position proximate to the horse. The dressage whip may have a handle which may be a shaft having a substantially oval cross section formed by two opposed substantially flat sides and two opposed substantially curved sides.

To this end, in an embodiment of the present invention, a dressage whip is provided. The dressage whip has a first segment having a first end and a second end wherein the second end is located in a position opposite to the first end and further wherein the first end of the first segment has a length and a width; a second segment having a first end and a second end wherein the second end is located in a position opposite to the first end wherein the first segment and the second segment define a line with which the first segment and the second segment are substantially co-linear; a curved segment which connects the first segment to the second segment wherein the curved segment is connected to the second end of the first segment and the first end of the second segment and further wherein the curved segment has an apex located between approximately one inch and approximately three inches from the line defined by the first segment and the second segment; an end cap attached to the first end of the first segment wherein the end cap has a length and a width and further wherein the length of the end cap is greater than the length of the first end of the first segment wherein the width of the end cap is greater than the width of the first end of the first segment; and a lash connected to the second end of the second segment.

In an embodiment, the apex is located approximately two inches from the line defined by the first segment and the second segment.

In an embodiment, the dressage whip has a first curved portion and a second curved portion which form the curved segment wherein the first curved portion is angled relative to the first segment at the same angle at which the second curved portion is angled relative to the second segment and further wherein the first curved portion extends from the first segment to the apex wherein the second curved portion extends from the apex to the second segment.

In an embodiment, the curved portion is symmetrical about the apex.

In an embodiment, the dressage whip has a first curved portion and a second curved portion which form the curved segment wherein the first curved portion and the second curved portion have the same length and further wherein the first curved portion extends from the first segment to the apex wherein the second curved portion extends from the apex to the second segment.

In an embodiment, the dressage whip has a handle attached to the first segment wherein the handle has raised portions and grooves and further wherein each of the grooves has one of the raised portions on one side of the groove and another one of the raised portions on the other side of the groove wherein the handle has a length and a width.

In an embodiment, the first segment and the curved segment are made of aluminum.

In an embodiment, the second segment is made of fiberglass.

In another embodiment of the present invention, a system for guiding a horse is provided. The system has a first segment having a first end and a second end wherein the second end is located in a position opposite to the first end; a second segment having a first end and a second end wherein the second end is located in a position opposite to the first end wherein the first segment and the second segment are substantially co-linear; a first curved portion having a first end and a second end wherein the second end is located in a position opposite to the first end wherein the first end of the first curved portion is connected to the second end of the first segment and further wherein the first curved portion is angled relative to the first segment at an angle between approximately ten degrees and approximately twenty degrees; and a second curved portion having a first end and a second end wherein the second end is located in a position opposite to the first end and further wherein the first end of the second curved portion which is connected to the second end of the first curved portion wherein the second end of the second curved portion is connected to the first end of the second segment and further wherein the second curved portion is angled relative to the second segment at an angle between approximately ten degrees and approximately twenty degrees.

In an embodiment, the angle of the first curved portion relative to the first segment and the angle of the second curved portion relative to the second segment is the same size.

In an embodiment, the second end of the first curved portion is connected to the first end of the second curved portion at an apex and further wherein the first segment and the second segment define a line with which the first segment and the second segment are substantially co-linear wherein the apex is located approximately two inches from the line defined by the first segment and the second segment.

In an embodiment, the first curved portion and the second curved portion are the same length.

In an embodiment, the first segment and the curved segment are made of aluminum and further wherein the second segment is made of fiberglass.

In an embodiment, the system has a handle attached to the first segment wherein the handle has raised portions and grooves and further wherein each of the raised portions has one of the grooves on one side of the raised portion and another one of the grooves on the other side of the raised portion.

In an embodiment, the system has an end cap attached to the first end of the first segment wherein the end cap is wider than the first segment.

In an embodiment, the system has a lash connected to the second end of the second segment wherein the lash is made of nylon.

In an embodiment, a method for a rider to guide a horse is provided. The method has the steps of simultaneously holding a dressage whip and reins wherein the rider simultaneously holds the dressage whip and the reins in one hand and further wherein the dressage whip has a first segment and second segment which are connected by a curved segment; accommodating a thigh of the rider in the dressage whip while the rider holds the dressage whip wherein the curved segment contacts the thigh of the rider when the thigh of the rider is accommodated by the dressage whip; and contacting the second segment of the dressage whip with the horse wherein the thigh of the rider maintains contact with the curved portion of the dressage whip as the second segment of the dressage whip is contacted with the horse.

In an embodiment, the method has the step of removing the second segment of the dressage whip from contact with the horse wherein the thigh of the rider maintains contact with the curved portion of the dressage whip as the second segment of the dressage whip is removed from contact with the horse.

In an embodiment, the first segment and the second segment are substantially co-linear.

In an embodiment, the dressage whip is formed by inserting a tapered fiberglass rod into an aluminum tube.

It is, therefore, an advantage of the present invention to provide a dressage whip and a system and a method for guiding a horse.

Another advantage of the present invention is to provide a dressage whip and a system and a method for guiding a horse which enable the rider to imperceptibly contact the dressage whip with the horse.

Yet another advantage of the present invention is to provide a dressage whip and a system and a method for guiding a horse which enable the rider to hold the reins and use the dressage whip easily and comfortably.

A still further advantage of the present invention is to provide a dressage whip and a system and a method for guiding a horse which enable the rider to contact the dressage whip with the horse using less movement relative to movement required by known dressage whips.

Another advantage of the present invention is to provide a dressage whip which enable a tip of the dressage whip to be maintained at a position closer to the side of the horse relative to known dressage whips.

Yet another advantage of the present invention is to provide a dressage whip and a system and a method for guiding a horse which enable a tip of the dressage whip to be maintained at a position approximately three inches to approximately six inches from the side of the horse.

A still further advantage of the present invention is to provide a dressage whip and a system and a method for guiding a horse which provide improved performance relative to known dressage whips but have a similar appearance to known dressage whips.

Moreover, an advantage of the present invention is to provide a dressage whip which has a curved segment to accommodate the thigh of the rider.

Additional features and advantages of the present invention are described in, and will be apparent from, the detailed description of the presently preferred embodiments and from the drawings.

### BRIEF DESCRIPTION OF THE DRAWINGS

FIG. 1 depicts a horse rider using a prior art dressage whip in a normal riding position.

FIG. 2 depicts a horse whip in an, embodiment of the present invention.

FIG. 3 depicts a horse whip handle in an embodiment of the present invention.

FIG. 4 depicts a horse whip handle in an embodiment of the present invention.

FIG. 5 depicts a horse whip handle in an embodiment of the present invention.

FIG. 6 depicts a horse rider holding a horse whip in an embodiment of the present invention.

### DETAILED DESCRIPTION OF THE PRESENTLY PREFERRED EMBODIMENTS

The present invention generally relates to a dressage whip and a system and a method for guiding a horse. More specifically, the present invention relates to a dressage whip which may have a curved segment and a tip. The curved segment may accommodate the thigh of a rider of the horse and may maintain the tip in a position proximate to the horse. The dressage whip may have a handle which may be a shaft having a substantially oval cross section formed by two opposed substantially flat sides and two opposed substantially curved sides.

Referring now to the drawings wherein like numerals refer to like parts, FIG. 1 generally illustrates a rider 10 of a horse 20 using a prior art dressage whip 100 in a normal riding position. The prior art dressage whip 100 is held in a hand 11 of the rider 10, and the hand 11 of the rider 10 also holds reins 21. The prior art dressage whip 100 is held proximate to a thigh 12 of the rider 10 to maintain an end 106 of the prior art dressage whip 100 from approximately ten inches to twelve inches from the side 22 of the horse 20. To actuate the prior art dressage whip 100, the rider 10 moves the hand 11 a sufficient distance to cause the end 106 of the prior art dressage whip 100 to contact the side 22 of the horse 20.

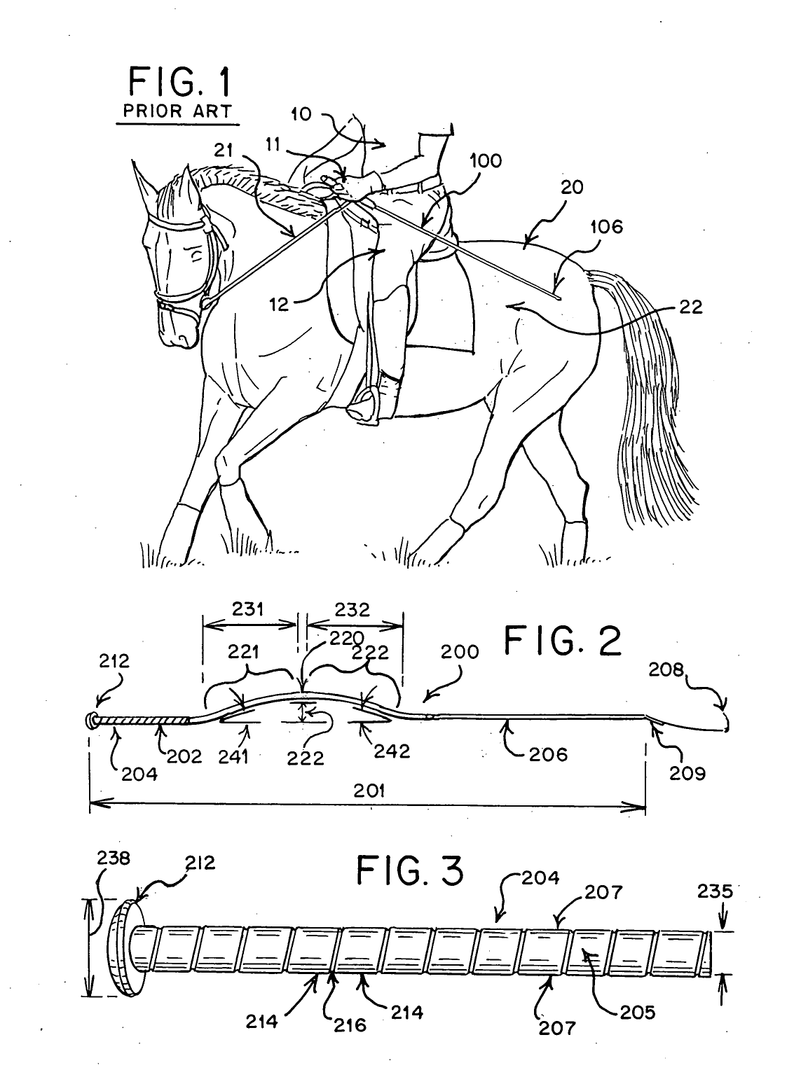

FIG. 2 depicts a dressage whip 200 (hereinafter “the whip 200”) in an embodiment of the present invention. The whip 200 may have a first segment 202 which may have a handle 204, and the whip 200 may have a second segment 206 located in a position opposite to the first segment 202. The second segment 206 may have a tip 209 to which a lash 208 may be attached. The lash 208 may be any material. In an embodiment, the lash 208 may be nylon. The whip 200 may have a curved segment 210 which may be located between the first segment 202 and the second segment 206. The curved segment 210 may connect the first segment 202 to the second segment 206. The first segment 202 and the second segment 206 may be co-linear such that the first segment 202 and the second segment 206 extend in the same direction and/or define a line.

The curved segment 210 may have an apex 220 about which the curved segment 210 may be symmetrical. For example, the curved segment 210 may be formed by a first curved portion 221 and/or a second curved portion 222. The first curved portion 221 may extend from the first segment 202 to the apex 220, and/or the second curved portion 222 may extend from the second segment 206 to the apex 220. The length 231 of the first curved portion 221 may be approximately equal to the length 232 of the second curved portion 222. In an embodiment, the length 231 of the first curved portion 221 and/or the length 232 of the second curved portion 222 may be between approximately six inches and approximately seven inches. In a preferred embodiment, the length 231 of the first curved portion 221 and/or the length 232 of the second curved portion 222 may be approximately 6.75 inches.

The first curved portion 221 may extend from the first segment 202 at a first angle 241, and/or the second curved portion 222 may extend from the second segment 206 at a second angle 242. The first angle 241 may be approximately the same size as the second angle 242. In an embodiment, the first angle 241 and/or the second angle 242 may be between approximately ten degrees and approximately twenty degrees. In a preferred embodiment, the first angle 241 and/or the second angle 242 may be approximately fifteen degrees. The present invention is not limited to a specific embodiment of the first angle 241, the second angle 242, the length 231 of the first curved portion 221, or the length 232 of the second curved portion 222.

As previously set forth, the first segment 202 and the second segment 206 may be co-linear such that the first segment 202 and the second segment 206 define a line. The apex 220 may have a distance 220 from the line defined by the first segment 202 and the second segment 206. In an embodiment, the distance 220 may be between approximately one inch and approximately three inches. In a preferred embodiment, the distance 220 may be approximately two inches. The present invention is not limited to a specific embodiment of the distance 220.

The curved segment 210 may be configured to accommodate the thigh 12 of the rider 10 while the rider 10 rides the horse 20 in the normal position such that the hand 11 which holds the whip 200 may also hold the reins 21. In the normal position of the rider 10, the curved segment 210 may rest over the thigh 12 of the rider 10 and/or may enable the tip 209 to be maintained closer to the side 22 of the horse 20. As a result, the whip 200 may enable the rider 10 to contact the side 22 of the horse 20 with the whip 200 using less movement of the hand 11.

In an embodiment, the curved segment 210 may maintain the tip 209 at a position between approximately three inches and approximately six inches from the side 22 of the horse 10. The position of the tip 209 between approximately three inches and approximately six inches from the side 22 of the horse 10 may assist novice riders in obtaining stable rein contact and/or steady hand position and/or may assist advanced riders in refining almost imperceptible aids for upper level movements.

In an embodiment, the first segment 202 and/or the curved segment 210 may be aluminum, and/or and the second segment 206 may be fiberglass. The whip 200 may have a length 201 which may be between approximately one hundred centimeters and approximately one hundred twenty centimeters. In a preferred embodiment, the length 201 of the whip 200 may be approximately one hundred centimeters. The present invention is not limited to a specific embodiment of the materials of the first segment 202, the curved segment 210 and the second segment 206, or a specific embodiment of the length 201 of the whip 200.

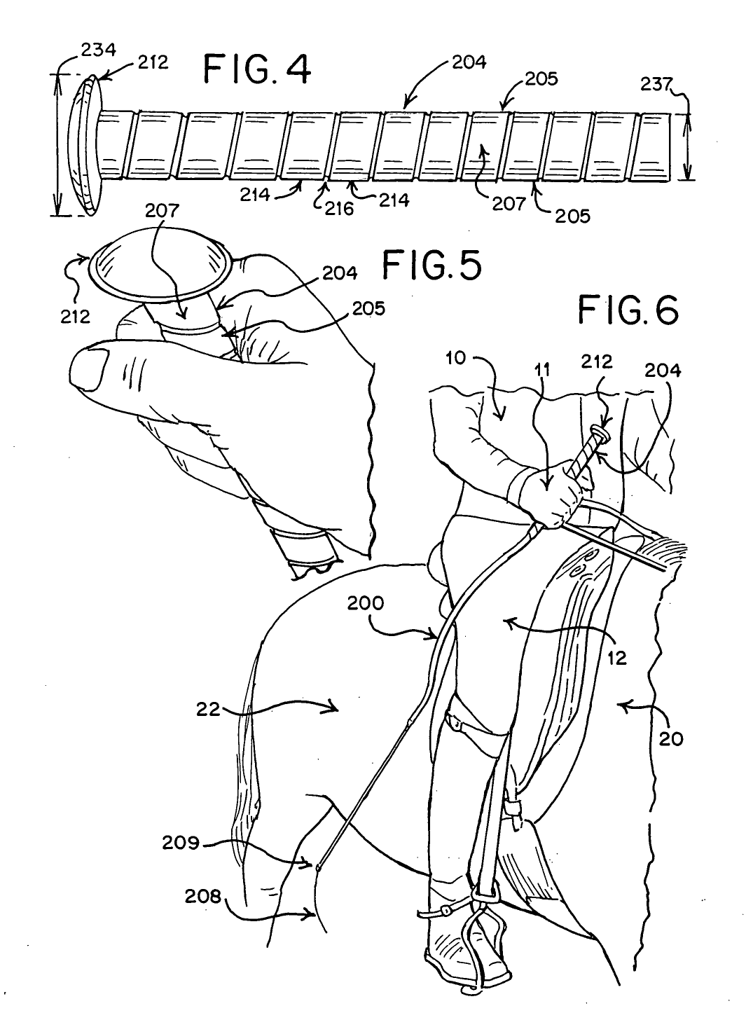

FIGS. 3 and 4 generally illustrate an embodiment of the handle 204. FIG. 5 generally illustrates the handle 204 being gripped by the rider 10. FIG. 6 generally illustrates the rider 10 holding an embodiment of the whip 200. In an embodiment, the handle 204 may be a material which may be softer than the aluminum of the first segment 202 and/or the curved segment 210 and/or the fiberglass of the second segment 206 to provide grip and comfort. As shown in FIGS. 3-6, the handle 204 may be a shaft having a substantially oval cross-section which may be formed by two opposed substantially flat sides 207 and two opposed substantially curved sides 205.

Each of the two opposed substantially curved sides 205 may have a width 235, and the width 235 of each of the substantially curved sides 205 may be an approximately equal distance. Each of the two opposed substantially flat sides 207 may have a width 237, and the width 237 of each of the substantially flat sides 207 may be an approximately equal distance. The two opposed substantially flat sides 207 may be broader than the two opposed substantially curved sides 205. For example, the width 235 of each of the substantially curved sides 205 may be a smaller distance than the width 237 of each of the substantially flat sides 207.

The handle 204 may have raised portions 214 and/or may have grooves 216 located between the raised portions 214. For example, each of the raised portions 214 may have one of the grooves 216 located on one side of the raised portion 214 and another one of the grooves located on the opposite side of the raised portion 214. In an embodiment, the handle 204 may accommodate the hand 11 of the rider 10 such that the raised portions 214 and/or the grooves 216 may accommodate fingers (not shown) of the rider 10. Accordingly, the handle 204 may provide secure and/or comfortable gripping.

An end cap 212 may be attached to the handle 204. The end cap 212 may have a substantially oval shape and/or may have a width 238 and a length 239. As illustrated in FIG. 3, the length 239 of the end cap 212 may be a larger distance than the width 237 of each of the substantially flat sides 207. As illustrated in FIG. 4, the width 238 of the end cap 212 may be a larger distance than the width 235 of each of the substantially curved sides 205. As a result, the end cap 212 may maintain a position of the hand 11 of the rider 10 in contact with the handle 204.

An embodiment of the whip 200 may be made using the following process. A first aluminum tube may be cut at a desired length. Then, the first aluminum tube may be bent and/or may be shaped to form the first segment 202 and/or the curved segment 210. The handle 204 may be formed by a second aluminum tube which may have a larger diameter than the first aluminum tube. The second aluminum tube may be cut at a desired length. Then, the second aluminum tube may be pressed into an oval-like cross section. The handle 204 may be formed by fitting and/or securing the second aluminum tube over the first segment 202 of the whip 200 formed by the first aluminum tube. Grip tape may be wrapped around the handle 204 to provide desired texture. The end cap 212 may be connected to the handle 204.

The second segment 206 of the whip 200 may be formed by inserting a tapered fiberglass rod into the first aluminum tube. Sleeving material (not shown) may cover the handle 204, the first segment 202, the curved segment 210 and/or the second segment 206. In an embodiment, the sleeving material may cover the entirety of the whip 200. The sleeving material may be secured at both ends of the whip 200. A finish and/or a coating may be applied to the sleeving material. The lash 208 may be attached to the tip 209 of the whip 200.

The whip 200 may be held in the hand 11 of the rider 10, and the hand 11 of the rider 10 may also hold the reins 21. To actuate the whip 200, the rider 10 moves the hand 11 to cause the whip 200 to contact the side 22 of the horse 20. The curved segment 210 may accommodate the thigh 12 of the rider 10; accordingly, less hand movement may be required to contact the whip 200 with the side 22 of the horse 20 and/or to remove the whip 200 from contact with the side 22 of the horse 20. The curved segment 210 may maintain contact with the thigh 12 of the rider 10 during contact of the whip 200 with the horse 20 and/or removal of the whip 200 from contact with the horse 200; accordingly, the rider 10 may more easily control the whip 200.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A dressage whip comprising:
a first segment having a first end and a second end wherein the second end is located in a position opposite to the first end and further wherein the first end of the first segment has a length and a width;
a second segment having a first end and a second end wherein the second end is located in a position opposite to the first end wherein the first segment and the second segment define a line with which the first segment and the second segment are substantially co-linear;
a curved segment which connects the first segment to the second segment wherein the curved segment is connected to the second end of the first segment and the first end of the second segment and further wherein the curved segment has an apex located between approximately one inch and approximately three inches from the line defined by the first segment and the second segment;
an end cap attached to the first end of the first segment wherein the end cap has a length and a width and further wherein the length of the end cap is greater than the length of the first end of the first segment wherein the width of the end cap is greater than the width of the first end of the first segment; and
a lash connected to the second end of the second segment.

2. The dressage whip of claim 1 wherein the apex is located approximately two inches from the line defined by the first segment and the second segment.

3. The dressage whip of claim 1 further comprising:
a first curved portion and a second curved portion which form the curved segment wherein the first curved portion is angled relative to the first segment at the same angle at which the second curved portion is angled relative to the second segment and further wherein the first curved portion extends from the first segment to the apex wherein the second curved portion extends from the apex to the second segment.

4. The dressage whip of claim 1 wherein the curved portion is symmetrical about the apex.

5. The dressage whip of claim 1 further comprising:
a first curved portion and a second curved portion which form the curved segment wherein the first curved portion and the second curved portion have the same length and further wherein the first curved portion extends from the first segment to the apex wherein the second curved portion extends from the apex to the second segment.

6. The dressage whip of claim 1 further comprising:
a handle attached to the first segment wherein the handle has raised portions and grooves and further wherein each of the grooves has one of the raised portions on one side of the groove and another one of the raised portions on the other side of the groove wherein the handle has a length and a width.

7. The dressage whip of claim 1 wherein the first segment and the curved segment are made of aluminum.

8. The dressage whip of claim 1 wherein the second segment is made of fiberglass.

9. A system for guiding a horse, the system comprising:
a first segment having a first end and a second end wherein the second end is located in a position opposite to the first end;
a second segment having a first end and a second end wherein the second end is located in a position opposite to the first end wherein the first segment and the second segment are substantially co-linear;
a first curved portion having a first end and a second end wherein the second end is located in a position opposite to the first end wherein the first end of the first curved portion is connected to the second end of the first segment and further wherein the first curved portion is angled relative to the first segment at an angle between approximately ten degrees and approximately twenty degrees; and
a second curved portion having a first end and a second end wherein the second end is located in a position opposite to the first end and further wherein the first end of the second curved portion which is connected to the second end of the first curved portion wherein the second end of the second curved portion is connected to the first end of the second segment and further wherein the second curved portion is angled relative to the second segment at an angle between approximately ten degrees and approximately twenty degrees.

10. The system of claim 9 wherein the angle of the first curved portion relative to the first segment and the angle of the second curved portion relative to the second segment is the same size.

11. The system of claim 9 wherein the second end of the first curved portion is connected to the first end of the second curved portion at an apex and further wherein the first segment and the second segment define a line with which the first segment and the second segment are substantially co-linear wherein the apex is located approximately two inches from the line defined by the first segment and the second segment.

12. The system of claim 9 wherein the first curved portion and the second curved portion are the same length.

13. The system of claim 9 wherein the first segment and the curved segment are made of aluminum and further wherein the second segment is made of fiberglass.

14. The system of claim 9 further comprising:
a handle attached to the first segment wherein the handle has raised portions and grooves and further wherein each of the raised portions has one of the grooves on one side of the raised portion and another one of the grooves on the other side of the raised portion.

15. The system of claim 9 further comprising:
an end cap attached to the first end of the first segment wherein the end cap is wider than the first segment.

16. The system of claim 9 further comprising:
a lash connected to the second end of the second segment wherein the lash is made of nylon.

17. A method for a rider to guide a horse, the method comprising the steps of:
simultaneously holding a dressage whip and reins wherein the rider simultaneously holds the dressage whip and the reins in one hand and further wherein the dressage whip has a first segment and second segment which are connected by a curved segment;
accommodating a thigh of the rider in the dressage whip while the rider holds the dressage whip wherein the curved segment contacts the thigh of the rider when the thigh of the rider is accommodated by the dressage whip; and
contacting the second segment of the dressage whip with the horse wherein the thigh of the rider maintains contact with the curved portion of the dressage whip as the second segment of the dressage whip is contacted with the horse.

18. The method of claim 17 further comprising the step of:
removing the second segment of the dressage whip from contact with the horse wherein the thigh of the rider maintains contact with the curved portion of the dressage whip as the second segment of the dressage whip is removed from contact with the horse.

19. The method of claim 17 wherein the first segment and the second segment are substantially co-linear.

20. The method of claim 17 wherein the dressage whip is formed by inserting a tapered fiberglass rod into an aluminum tube.
